(19) United States
(12) Patent Application Publication
(10) Pub. No.: US 2025/0075864 A1
(43) Pub. Date: Mar. 6, 2025

(54) SYSTEMS AND METHODS OF PREVENTING HYDRATE FORMATION IN GAS PIPELINES

(71) Applicant: SAUDI ARABIAN OIL COMPANY, Dhahran (SA)

(72) Inventor: Faares Khalid DANDENI, Dhahran (SA)

(73) Assignee: SAUDI ARABIAN OIL COMPANY, Dhahran (SA)

(21) Appl. No.: 18/458,272

(22) Filed: Aug. 30, 2023

(51) Int. Cl. F17D 3/14

(52) U.S. Cl. CPC F17D 3/145

(57) ABSTRACT

A pipeline system includes a pipeline that conveys natural gas and includes a choke valve, one or more adjustable restriction orifices arranged within the pipeline upstream from the choke valve and spaced from each other to define at least first and second pipeline sections, each adjustable restriction orifice including an actuation mechanism, a first pressure gauge in communication with the first pipeline section, and a second pressure gauge in communication with the second pipeline section, and a control system in communication with the first and second pressure gauges and the actuation mechanism of each adjustable restriction orifice. The control system communicates with the actuation mechanism to adjust a size of the adjustable restriction orifices when at least one of the pressure gauges measures and reports a pressure below or exceeding a predetermined pressure threshold.

### FIELD OF THE DISCLOSURE

The present disclosure relates generally to fluid flow through gas pipelines and, more particularly, to systems and methods of preventing hydrate formation in gas pipelines using adjustable restriction orifices and selective heating.

### BACKGROUND OF THE DISCLOSURE

Hydrates, or natural-gas hydrates, can hinder the production of natural gas through surface positioned pipelines. Hydrate formation occurs when conditions within a pipeline are ideal for their generation, and conventional natural gas production operations often create such ideal conditions. More specifically, hydrates form in the presence of gas, free water, low temperature and high pressure, the combination of which commonly occurs during the production of natural gas. Over time, the hydrates can build up and restrict pipeline flow area, thereby reducing the volume of natural gas that can pass through and correspondingly decreasing production rates.

Conventional hydrate formation mitigation methods are costly and often inefficient. A method of preventing hydrate formation that is both effective and cost efficient is desirable.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a pipeline system may include a pipeline that conveys natural gas and a choke valve arranged within the pipeline with one or more adjustable restriction orifices arranged within the pipeline upstream from the choke valve. Wherein the one or more adjustable restriction orifices may be spaced from each other to thereby define at least a first pipeline section and a second pipeline section within the pipeline. Additionally, each adjustable restriction orifice may include an actuation mechanism. The pipeline system may include a first pressure gauge in communication with the first pipeline section and a second pressure gauge in communication with the second pipeline section, as well as a control system in communication with the first and second pressure gauges and the actuation mechanism of each adjustable restriction orifice. The control system may communicate with the actuation mechanism to adjust a size of the one or more adjustable restriction orifices when at least one of the first and second pressure gauges measures and reports a pressure below or exceeding a predetermined pressure threshold, thereby altering a pressure within the pipeline.

According to another embodiment consistent with the present disclosure, a method of hydrate formation prevention may include conveying natural gas in a pipeline, wherein the pipeline may include a choke valve arranged in the pipeline and one or more adjustable restriction orifices arranged within the pipeline upstream from the choke valve. The one or more adjustable restriction orifices may be spaced from each other to thereby define at least a first pipeline section and a second pipeline section. The method may include monitoring a first pressure within the first pipeline section with a first pressure gauge and monitoring a second pressure within the second pipeline section with a second pressure gauge. The method may include communicating the first and second pressures to a control system in communication with the first and second pressure gauges and communicating a command signal from the control system to an actuation mechanism of at least one of the one or more adjustable restriction orifices when at least one of the first and second pressures exceeds a predetermined pressure threshold. The method may include adjusting a size of the at least one of the one or more adjustable restriction orifices based on the command signal and thereby altering the first or second pressures within the pipeline.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic side view of an example pipeline system that may incorporate the principles of the present disclosure, according to one or more embodiments.

FIG. 2 is a schematic flowchart of an example method of preventing hydrate formation, according to one or more embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to natural gas production through pipelines and, more particularly, to a method of natural gas production that aids in preventing and mitigating hydrate formation in pipelines. Natural gas hydrates form in pipelines when natural gas (e.g., CH₄) and free water or moisture circulate at low temperatures and high pressure simultaneously. Conventional natural gas production via pipeline is prime for the creation of hydrates since the elements required to generate hydrates are often prevalent. When natural gas is produced and extracted from a subterranean wellbore, the gas is initially transported away from the wellbore (e.g., from a wellhead) at the well surface by means of a production pipeline. (In offshore-based operations the “well surface” may be the seafloor and similarly, in land-based operations, the “well surface” may be in reference to the surface of the Earth exposed to the atmosphere.) If formed in production pipelines, the hydrates can slow natural gas production, or in extreme cases, cause a complete shutdown.

The systems and methods of hydrate mitigation disclosed herein do not require extensive equipment nor extreme over-sight on the part of the operator. The presently-described systems and methods are also advantageous because they do not require the injection of costly inhibitor chemicals. Further, the systems disclosed herein may be self-regulating, and thus capable of creating more efficiency in the production operation overall.

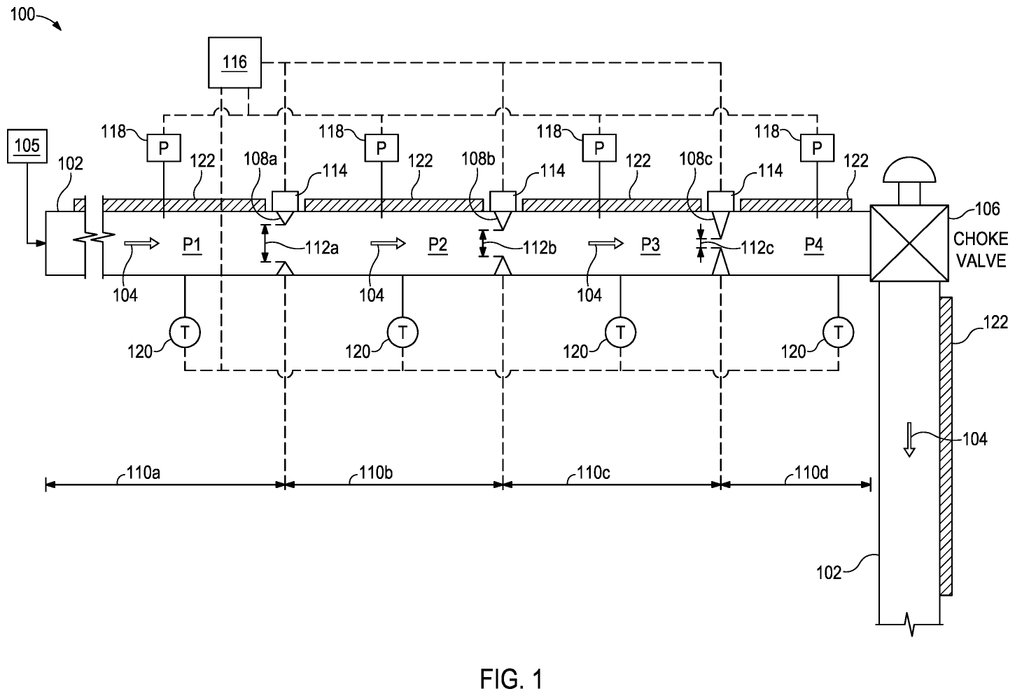

FIG. 1 is a schematic side view of an example pipeline system 100 that may incorporate the principles of the present disclosure, according to one or more embodiments. The pipeline system 100 (hereafter “the system 100”) includes an extension (or length) of a pipeline 102. The pipeline 102 may comprise any type of tubular, pipe, or conduit commonly used in the oil and gas industry, and may be made of a variety of materials. In at least one embodiment, the pipeline 102 may be operable to transport a gas, such as natural gas 104. In some embodiments, the pipeline 102 may extend from a wellhead 105 or “Christmas tree” (not shown) in fluid communication with a natural gas producing wellbore (not shown). In such embodiments, the Christmas tree may be positioned over a subterranean formation and include a sub-surface safety valve (SSSV), and the pipeline 102 may be fluidly coupled to a production line extending from valves included in the Christmas tree. In other embodiments, however, the pipeline 102 may form part of a gas transmission line or conduit located at any other location, such as a gas processing facility or the like.

The pipeline 102 may be designed, fabricated and configured according to the specific requirements of the operation. The pipeline 102 may further be configured so as to comply with applicable regulatory agency requirements and in accordance with industry standardization organizations including but not limited to the International Standards Organization (ISO), American Petroleum Institute (API), American Society of Mechanical Engineers (ASME) and Saudi Arabian Standards Organization (SASO).

Accordingly, the design specifications of the pipeline 102 may be specific to the producing well, the operator, and or the region in which the natural gas 104 is being produced, but is not considered to be limiting to the methods and apparatuses of hydrate prevention and mitigation disclosed herein.

In wells producing natural gas 104 at high pressures (e.g., 8,000-10,000 psi), the natural gas 104 exhibits the same or similar high pressure upon reaching the well surface. However, to transport the produced natural gas 104 safely from the wellhead 105 to a downstream location (e.g., a production/processing facility, a compressor station, etc.) the pressure within the pipeline 102 must be reduced significantly. Pressure reduction is commonly accomplished by manipulating a choke valve 106 arranged within the pipeline 102, and positioned at a predetermined distance downstream from the wellhead 105. The predetermined distance may be between about 10 meters (˜32.8 feet) and about 20 meters (˜65.6 feet) from the wellhead, but could fall outside that range, without departing from the scope of this disclosure.

When the well is put on production, natural gas 104 exits the wellhead 105 and travels into and through the pipeline 102 until it reaches the choke valve 106 where the natural gas 104 retains the same or similar high pressure (e.g., 8,000-10,000 psi). In some cases, the choke valve 106 can reduce the pressure of the natural gas 104 to around 2,000 psi or less, and in other cases, choke valve 106 can reduce the pressure of the natural gas 104 to 1,500 psi or lower, such as within an operating range of approximately 500 to 1,500 psi. As a result, the natural gas 104 transported downstream of the choke valve 106 will circulate at a significantly lower pressure than the initial production pressure.

By reducing the pressure of the natural gas 104 from around 8,000 psi to around 1,500 psi as it traverses the choke valve 106, the natural gas 104 will experience a congruent drop in temperature due to the Joule-Thomson effect, wherein in a change in pressure induces a concurrent change in temperature. As a result, the conditions are excellent for hydrate formation because the natural gas 104 as it is produced and travels through the pipeline 102 includes some amount of moisture. In instances where hydrates do form, blockages may develop in the choke valve 106 and/or the pipeline 102 downstream from the choke valve 106. Such blockages may slow the rate of natural gas 104 flow through the pipeline 102 downstream from the choke valve 106, or in some severe occurrences halt natural gas 104 production entirely.

Prevention measures are often implemented in an effort to prevent, mitigate, or reverse the formation of hydrates within pipelines, and thereby ensure or restore the rate of natural gas 104 production. In some applications, for example, chemical hydrate inhibitors are injected throughout the pipeline system 100 to prevent slowdown (or shutdown) due to hydrate buildup. Examples hydrate inhibitors include, but are not limited to, mono ethylene glycol (MEG), methanol, kinetic hydrate inhibitors (KHI), or any combination thereof. In such applications, the hydrate inhibitor is injected upstream from the choke valve 106 so that the flow of the natural gas 104 carries the inhibitor through the choke valve 106 and into the downstream portions of the pipeline 102.

According to embodiments of the present disclosure, instead of relying on expensive hydrate inhibitors and chemical injecting, hydrate formation in the pipeline 102 may be prevented and/or mitigated by regulating the pressure of the natural gas 104 within the pipeline 102 upstream of the choke valve 106, and by maintaining the temperature of the pipeline 102 above the temperature at which hydrates may form. As described in more detail below, the system 100 may further include one or more restriction orifices positioned within the pipeline 102 upstream of the choke valve 106 to progressively and sequentially reduce the pressure of the natural gas 104 before reaching the choke valve 106. The system 100 may also include one or more heating elements configured to help maintain the temperature of the natural gas 104 above the temperature at which hydrates might form.

As illustrated, the system 100 may include one or more restriction orifices positioned within the pipeline 102 upstream of the choke valve 106 to help control and regulate the flow and pressure of the natural gas 104 within the pipeline 102. In the illustrated embodiment, the system 100 includes three restriction orifices, shown as a first restriction orifice 108a, a second restriction orifice 108b, and a third restriction orifice 108c. While three restriction orifices 108a-c are included in the system 100, more or less than three may be employed, without departing from the scope of the disclosure.

The restriction orifices 108a-c may be equidistantly or non-equidistantly spaced from each other along the length of the pipeline 102 upstream of the choke valve 106. Regardless of spacing, the restriction orifices 108a-c effectively divide the pipeline 102 into a plurality of discrete sections, shown as a first pipeline section 110a, a second pipeline section 110b, a third pipeline section 110c, and a fourth pipeline section 110d, where the fourth pipeline section 110d is fluidly adjacent and connected to the choke valve 106. The restriction orifices 108a-c may be configured to gradually and progressively decrease the pressure of the natural gas 104 as it flows toward the choke valve 106, such that the pressure of the natural gas 104 in each pipeline section 110a-d may be decreased step-wise.

More particularly, the restriction orifices 108a-c may permit passage of the natural gas 104 through the pipeline 102, but each restriction orifice 108a-c may exhibit a diameter that is progressively less than the diameter of the pipeline 102, thus progressively and gradually reducing the pressure of the natural gas 104 as it circulates toward the choke valve 106. In the illustrated example, the first restriction orifice 108a may exhibit a first diameter or “size” 112a, the second restriction orifice 108b may exhibit a second diameter or “size” 112b smaller than the first size 112a, and the third restriction orifice 108c may exhibit a third diameter or “size” 112c smaller than the second size 112b; e.g., 112a>112b>112c.

In an example operation, the natural gas 104 may flow from the wellhead 105 into the first pipeline section 110a at a first or “initial” pressure P1, which may be about 8,000-10,000 psi. As the natural gas 104 traverses (flows through) the first restriction orifice 108a and is discharged into the second pipeline section 110b, the pressure of the natural gas 104 is reduced to a second pressure P2 lower than the first pressure P1; e.g., P1>P2. In some embodiments, for example, the second pressure P2 may be about 6,000 psi. The natural gas 104 flowing through the second pipeline section 110b at the second pressure P2 may then circulate through the second restriction orifice 108b and be discharged into the third pipeline section 110c. Traversing the second restriction orifice 108b may reduce the pressure of the natural gas 104 to a third pressure P3 lower than the second pressure P2; e.g., P2>P3. In some embodiments, for example, the third pressure P3 may be about 4,000 psi. The natural gas 104 flowing through the third pipeline section 110b at the third pressure P3 may then circulate through the third restriction orifice 108c and be discharged into the fourth pipeline section 110d. Traversing the third restriction orifice 108c may reduce the pressure of the natural gas 104 to a fourth pressure P4 lower than the third pressure P3; e.g., P3>P4. In some embodiments, for example, the fourth pressure P4 may be about 2,000 psi.

Accordingly, in at least one embodiment, the natural gas 104 may encounter and circulate through the choke valve 106 at a pressure of about 2,000 psi. Consequently, the likelihood of hydrate formation within or downstream from the choke valve 106 is reduced since a dramatic and substantial pressure drop in the natural gas 104 is no longer required at the choke valve 106. Rather, the choke valve 106 may be configured to further reduce the pressure of the natural gas 104 from about 2,000 psi to about 1,500 psi or less. As a result, the potential formation of hydrates downstream from the choke valve 106 is drastically reduced.

The restriction orifices 108a-c may be susceptible to erosion given the large volume of high pressure natural gas 104 to which they may be exposed to over time. Accordingly, in at least one embodiment, the restriction orifices 108a-c may be made of an erosion-resistant material and otherwise of a material less prone to erosion and capable of withstanding high flowrates and pressures. Example erosion-resistant materials for the restriction orifices 108a-c include, but are not limited to, tungsten carbide, stainless steel, a metal alloy (e.g., INCONEL®), or any combination or alloy thereof.

In some embodiments, one or more of the restriction orifices 108a-c may comprise reduced diameter sections of the pipeline 102. In such embodiments, the restriction orifices 108a-c may form an integral part and extension of the pipeline 102 and extend radially inward from the inner circumferential surface of the pipeline 102. In other embodiments, however, one or more of the restriction orifices 108a-c may comprise separate component parts capable of being secured within the interior of the pipeline 102 at predetermined locations.

In yet other embodiments, one or more of the restriction orifices 108a-c may be adjustable and otherwise actuatable to selectively adjust the diameter 112a-c as needed. In such embodiments, the diameter 112a-c of the restriction orifices 108a-c may be selectively decreased (on demand) to restrict more flow of the natural gas 104, and thereby resulting in a greater pressure drop across the corresponding restriction orifice 108a-c. Alternatively, the diameter 112a-c of the restriction orifices 108a-c may be selectively increased (on demand) to allow more fluid to pass through the respective restriction orifices 108a-c, thus resulting in less pressure drop. The ability to selectively adjust the diameter 112a-c of the restriction orifices 108a-c may prove advantageous in operating the well throughout its life span. More specifically, fluid pressures from a well may gradually decrease over time, and thus require less pressure drop across the choke valve 106 to transport the natural gas 104 at lower, safer pressures. Having the ability to selectively adjust the diameter 112a-c of the restriction orifices 108a-c may eliminate the need to replace static (non-adjustable or non-actuatable) restriction orifices when the inlet pressure changes.

In embodiments where the restriction orifices 108a-c are adjustable, the restriction orifices 108a-c may comprise a variety of types of adjustable orifices actuatable by a corresponding actuation mechanism 114. In such embodiments, the actuation mechanisms 114 may be configured for hydraulic actuation, pneumatic actuation, mechanical actuation, electromechanical actuation, or any combination thereof. In at least one embodiment, the actuation mechanism 114 may be omitted and the adjustable restriction orifices 108a-c may be self-regulating. In such embodiments, the adjustable restriction orifices 108a-c may be configured to naturally react and alter the corresponding diameter 112a-c based on a pressure assumed on the adjustable restriction orifice 108a-c.

Examples of the adjustable restriction orifices 108a-c include, but are not limited to, an adjustable iris, radially adjustable orifice plate, angularly adjustable orifice plates, or any type of mechanism configured to adjust a size or diameter of an orifice. Radially adjustable orifice plates include opposing plates that can be moved radially inward or outward to selectively adjust the orifice size. Angularly adjustable orifice plates include plates with slots defined therein, and angularly adjusting the orientation of one of the plates relative to the other restricts fluid flow through the slots, thereby effectively adjusting the orifice size. The principles of the present disclosure cover any known adjustable restriction orifice operable to vary the diameter and/or restrict the flow of natural gas 104 through the pipeline 102.

In embodiments where the restriction orifices 108a-c are adjustable, the system 100 may further include one or more control systems 116 (one shown) in communication with the restriction orifices 108a-c and, more particularly, with the corresponding actuation mechanism 114 configured to actuate (operate) the adjustable restriction orifices 108a-c. The control system(s) 116 may communicate with the actuation mechanisms 114 via any wired or wireless means of telecommunication. In some embodiments, the control system(s) 116 may comprise a programmable logic controller (PLC), with a processor and a memory that has computer-readable instructions stored thereon and readable and executable by the processor. In other embodiments, the control system(s) 116 may comprise any programmable control system capable of communication and executing instructions.

In some embodiments, as illustrated, each actuation mechanism 114 may communicate with a single control system 116 operable to selectively actuate each restriction orifice 108a-c individually or jointly. In other embodiments, however, the system 100 may include a plurality of control systems 116. In such embodiments, each actuation mechanism 114 may be in communication with a dedicated and discrete control system 116, and such discrete control systems 116 may form an integral part of each actuation mechanism 114.

The control system 116 may be programmed or otherwise configured to autonomously or automatically actuate the restriction orifices 108a-c to operate and thereby selectively adjust the diameter 112a-c to regulate the pressure of the natural gas 104 within the pipeline 102. In such embodiments, the restriction orifices 108a-c may be characterized as “self-regulating” restriction orifices. This may be particularly advantageous in remote or offshore applications where it may be difficult to manually adjust or replace the restriction orifices 108a-c with different diameters. Similarly, self-regulating restriction orifices 108a-c may be particularly advantageous in operations where there exists a large volume of wells producing and transporting natural gas 104 via the same system 100.

In some embodiments, the pressure P1-P4 within each pipeline section 110a-d and across one or more of the restriction orifices 108a-c may be monitored periodically or in real-time. To accomplish this, the system 100 may further include one or more pressure gauges 118 (alternately referred to as “pressure indicator transmitters”) arranged to obtain pressure measurements from within the interior of the pipeline 102. In the illustrated embodiment, four pressure gauges 118 are shown in communication with the interior of the pipeline 102 at each pipeline section 110a-d and configured to monitor and report the pressure P1-P4 in each corresponding pipeline section 110a-d. In other embodiments, more or less than four pressure gauges 118 may be included in the system 100.

In some embodiments, the pressure gauges 118 may be in communication with the control system 116. In such embodiments, real-time pressure measurements may be conveyed to the control system 116 for processing and/or storage. In some embodiments, when the pressure P1-P4 within one or more of the pipeline sections 110a-d exceeds (above or below) a predetermined pressure threshold or value, the control system 116 may be configured to communicate a command signal to adjust the size (diameter) 112a-c of the corresponding restriction orifice 108a-c, and thereby alter the pressure P1-P4 within the corresponding pipeline section 110a-d. As will be appreciated, the control system 116 may be operable to increase or decrease the size (diameter) 112a-c of each restriction orifice 108a-c, thereby resulting in larger or lesser pressure drops across the corresponding restriction orifice 108a-c.

By way of an example, the control system 116 may be programmed to monitor and maintain pressures within the pipeline 102 in which the initial estimated production pressure is 8,000 psi. In such an example, the operator may require the pressure of the natural gas 104 prior to entering the choke valve 106 to be approximately 2,000 psi, in an effort to mitigate and prevent hydrate formation. As such, the control system 116 may be programmed to maintain the pressure P1 in the first pipeline section 110a to be approximately 8,000 psi (+/−500 psi). Further, pipeline sections 110b-d may be programed to maintain pressure thresholds of about P2=6,000 psi, about P3=4,000 psi, and about P4=2,000 psi. In some embodiments, the pressures P2-P4 may be maintained within +/−500 psi of the programed pressure threshold. Similarly, prior to production, the restriction orifices 108a-c may be initially programmed to exhibit sizes (diameters) 112a-c that gradually decrease upon approaching the choke valve 106, based upon the same predetermined, estimated pressure thresholds.

In the example, the natural gas 104 enters the pipeline section 110a at the estimated pressure P1 of 8,000-10,000 psi. Because the natural gas 104 in section 110a is at or substantially near the estimated and programed first pressure P1 (as confirmed by the respective pressure gauge 118 readings transmitted to the control system 116) the restriction orifice 112a is accurately sized to impose an approximate 2,000 psi pressure loss. Consequently, upon entering the second pipeline section 110b, the natural gas 104 should ideally exhibit the second pressure P2 of about 6,000 psi (+/−500 psi). If however, the respective pressure gauge 118 indicates that the second pressure P2 exceeds or drops below 6,000 psi (+/−500 psi), the actuation mechanism 114 (by way of the control system 116) directs the restriction orifice 108c to adjust accordingly so that the natural gas 104 may be received by the third pipeline section 110c at or near the third P3 pressure threshold (i.e., about 4,000 psi). Similarly, if the second pressure P2 is measured outside the 6,000 psi threshold, an adjustment in the size (diameter) 112a of restriction orifice 108a may be triggered. An adjustment of the first restriction orifice 108a will further maintain the pressure threshold of natural gas 104 entering the second pipeline section 110b. As the natural gas 104 travels through the third restriction orifice 108c, the resultant third pressure P3 in the third pipeline section 110c should be approximately 4,000 psi (+/−500 psi). Similar to the immediately preceding pipeline sections 110a,b, if the third pressure P3 exceeds or drops below the 4,000 psi threshold, the third and fourth restriction orifices 108c and 108d may be triggered to autonomously adjust to ensure that the fourth pressure P4 in the fourth pipeline section 110d is approximately 2,000 psi.

In the disclosed example, maintaining the fourth pressure P4 of about 2,000 psi prevents an excessive pressure drop in the natural gas 104 traversing the choke valve 106 and consequently assists in preventing the formation of hydrates in the choke valve 106 and the pipeline 102 sections downstream from the choke valve 106.

Because the production pressure of the well is ever changing, autonomous adjustment of the restriction orifices 108a-c is enormously beneficial in hydrate prevention and mitigation. Real-time transmission of pressure readings from the pressure gauges 118 to the control system 116 allows for the maintenance of steadily declining natural gas 104 pressures through the pipeline sections 110a-d, thus preventing potential production slowdowns or stoppages due to hydrate formation. The control system 116 is particularly beneficial in areas where multiple wells are producing and connected to the same system 100 and similarly, in offshore or remote locations wherein manual adjustments to restriction orifices 108a-c may be difficult or near impossible.

As will be appreciated, the control system 116 may be programmed at the discretion of the operator. Programmable attributes the operator may impose include, but is not limited to, the frequency of transmitted pressure gauge 118 readings, pressure thresholds for each respective pipeline section 110a-d, and pressure threshold variance(s) (e.g., +/−500 psi).

In some embodiments, the temperature within each discrete pipeline section 110a-d may also be monitored periodically or in real-time. To accomplish this, the system 100 may further include one or more temperature gauges 120 (alternately referred to as “temperature indicator transmitters”) arranged to obtain temperature measurements within the interior of the pipeline 102. In the illustrated embodiment, individual temperature gauges 120 are shown in communication with the interior the pipeline 102 at each pipeline section 110a-d and configured to monitor and report the temperature of each corresponding pipeline section 110a-d. In other embodiments, more or less than four temperature gauges 120 may be included in the system 100.

In some embodiments, the temperature gauges 120 may be in communication with the control system 116 via any wired or wireless means of telecommunication. In such embodiments, real-time temperature measurements may be conveyed to the control system 116 for processing and/or storage. In some embodiments, when the temperature within one or more of the pipeline sections 110a-d drops below a predetermined threshold or value, the control system 116 may be configured to communicate a command signal to increase the temperature within the pipeline 102. In some embodiments, for example, the system 100 may further include one or more heating elements 122 operable to generate and convey heat to the pipeline 102. In such embodiments, the control system 116 may communicate with the heating elements 122 via any wired or wireless means of telecommunication to increase the temperature of the pipeline 102, and as a result, the natural gas 104, thereby preventing the natural gas 104 from descending below a predetermined temperature limit. In such an embodiment, the operator may program the frequency at which temperature readings are transmitted to the control system 116.

In some embodiments, the heating elements 122 may be operated via the actuation mechanisms 114. In such embodiments, communicating a signal to the actuation mechanisms 114 may cause operation of the heating elements 122. In at least one embodiment, the control system 116 may be communicably coupled to both the pressure gauges 118 and the temperature gauges 120. Consequently, the control system 116 enables hydrate prevention by simultaneous maintenance of the pressure and temperature within the pipeline 102 via the actuation mechanisms 114 and heating elements 122.

In at least one embodiment, one or more of the heating elements 122 may be enclosed within a shroud or covering extending about the exterior of the pipeline 102 to provide additional thermal insulation and thereby further prevent heat loss. The heating elements 122 may be powered by an external power source, but could alternatively be powered by any known means.

In some embodiments, one or more of the heating elements 122 may comprise a mineral-insulated (MI) metal-sheathed cable secured to the exterior the pipeline 102 and configured to generate heat continuously via an internal heating conductor. In other embodiments, one or more of the heating elements 122 may comprise a self-regulating heat trace cable attached to the exterior of the pipeline and configured to generate heat. In yet other embodiments, the heating elements 122 may be arranged within the pipeline 102 and operable to directly heat the natural gas 104.

In some embodiments, the heating element 122 may comprise a single device or mechanism that extends along all or substantially all of the axial length of the pipeline 102. In other embodiments, however, the system 100 may include a plurality of heating elements 122. In such embodiments, discrete heating elements 122 may be secured to the pipeline 102 at each pipeline section 110a-d and the control system 116 may be configured to communicate discrete command signals to each heating element 122. In some embodiments, as shown in FIG. 1, a heating element 122 may also be included on the pipeline 102 downstream from the choke valve 106.

Accordingly, the control system 116 may be in communication with the heating elements 122 as well as the pressure and temperature gauges 118, 120. The temperature gauges 120 may transmit real-time temperature readings to the control system 116, which may be programmed to actuate (trigger operation of) the heating elements 122 when one or more of the temperature gauges 120 detects a temperature below or above a predetermined temperature limit. In at least one embodiment, the predetermined temperature limit may be 120° F. In such an embodiment, once a temperature of 120° F. or lower is detected, the control system 116 may be programmed to trigger operation of the heating elements 122 to increase the temperature of the natural gas 104 to above 120° F. Similarly, the control system 116 may be programmed to deactivate the heating elements 122 once the temperature exceeds the predetermined temperature limit for a predetermined duration of time. Additionally, the control system 116 may be programmed with temperature threshold variance(s) (e.g., +/−10° F.) triggering the actuation of the heating elements 122 if a temperature outside the programmed threshold variance is recognized by the control system 116.

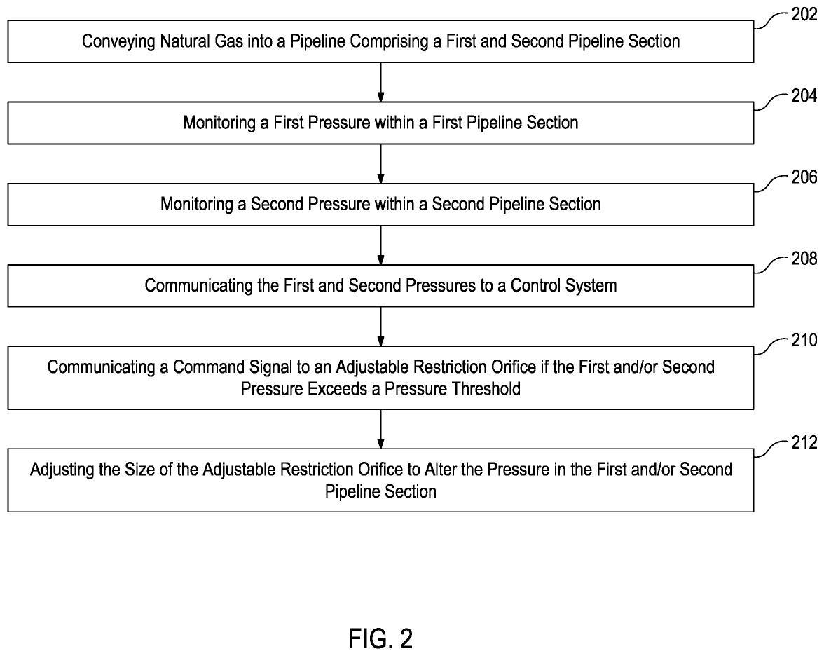

Referring now to FIG. 2, with continued reference to FIG. 1, illustrated is a schematic flowchart of an example method 200 of preventing hydrate formation, according to one or more embodiments of the present disclosure. The method 200, may first include conveying natural gas into a pipeline, as at 202. The pipeline may include a choke valve and one or more one or more adjustable restriction orifices arranged within the pipeline upstream from the choke valve. The adjustable restriction orifices may be spaced from each other to thereby define at least a first pipeline section and a second pipeline section. The method 200 may further include monitoring a first pressure within the first pipeline section with a first pressure gauge, as 204, and monitoring a second pressure within the second pipeline section with a second pressure gauge, as at 206. The first and second pressures may be obtained simultaneously and/or independently, and in real-time and/or periodically (i.e., on a set schedule).

The first and second pressures may be communicated to a control system that may in communication with the first and second pressure gauges, as at 208. Should at least one of the first and second pressures exceed a predetermined pressure threshold the control system may communicate a command signal to an actuation mechanism of the at least one of the one or more adjustable restriction orifices, as at 210. The method 200 may include adjusting a size of the adjustable restriction orifices based on the command signal and thereby altering the first or second pressures within the pipeline, as 212.

In the same pipeline and wherein the command signal communicated by the control system in response changing pressures within the pipeline comprises a first command signal, the method may also include monitoring and adjustments of the pipeline temperature. A first temperature within the first pipeline section with a first temperature gauge and a second temperature within the second pipeline section with a second temperature gauge, may be monitored. The first and second temperature gauges communicably coupled to the control system may then communicate first and second temperatures to the control system. Accordingly, a second command signal may be communicated from the control system to a heating element mounted to the pipeline at one or both of the first and second pipeline sections when at least one of the first or second temperatures descend below a predetermined temperature threshold. At which time, the method may include increasing at least one of the first and second temperatures with the heating element.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A pipeline system, comprising:
a pipeline that conveys natural gas;
a choke valve arranged within the pipeline;
one or more adjustable restriction orifices arranged within the pipeline upstream from the choke valve and spaced from each other to thereby define at least a first pipeline section and a second pipeline section within the pipeline, each adjustable restriction orifice including an actuation mechanism;
a first pressure gauge in communication with the first pipeline section, and a second pressure gauge in communication with the second pipeline section; and
a control system in communication with the first and second pressure gauges and the actuation mechanism of each adjustable restriction orifice,
wherein the control system communicates with the actuation mechanism to adjust a size of the one or more adjustable restriction orifices when at least one of the first and second pressure gauges measures and reports a pressure below or exceeding a predetermined pressure threshold, thereby altering a pressure within the pipeline.

2. The pipeline system of claim 1, further comprising:
a first temperature gauge communicably coupled to the control system and arranged to measure a first temperature within the first pipeline section;
a second temperature gauge communicably coupled to the control system and arranged to measure a second temperature within the second pipeline section; and
a heating element mounted to the pipeline at one or both of the first and second pipeline sections and in communication with the control system,
wherein the control system operates the heating element to increase a temperature of the pipeline when at least one of the first and second temperatures descends below a predetermined temperature threshold.

3. The pipeline system of claim 2, wherein the predetermined temperature threshold is 120° F.

4. The pipeline system of claim 2, wherein the heating element comprises a heat trace cable.

5. The pipeline system of claim 1, wherein the pipeline extends from a wellhead operable to receive and transmit the natural gas from a wellbore.

6. The pipeline system of claim 1, wherein one or more adjustable orifices include:
a first adjustable restriction orifice exhibiting a first diameter and interposing the first and second pipeline sections; and
a second adjustable restriction orifice exhibiting a second diameter smaller than the first diameter and arranged downstream from the first adjustable restriction orifice.

7. The pipeline system of claim 6, wherein a pressure of the natural gas upstream from the first adjustable restriction orifice is about 8,000-10,000 psi, and the pressure of the natural gas traversing the choke valve is about 2,000 psi.

8. The pipeline system of claim 1, wherein the restriction orifices are made of an erosion-resistant material selected from the group consisting of tungsten carbide, stainless steel, a metal alloy, and any combination or alloy thereof.

9. The pipeline system of claim 1, wherein the actuation mechanism is configured for at least one of hydraulic actuation, pneumatic actuation, mechanical actuation, electromechanical actuation, and any combination thereof.

10. The pipeline system of claim 1, wherein the one or more adjustable restriction orifices are selected from the group consisting of an adjustable iris, radially adjustable orifice plates, angularly adjustable orifice plates, and any combination thereof.

11. The pipeline system of claim 1, wherein the control system comprises a plurality of discrete control systems communicably coupled to and forming an integral part of each actuation mechanism.

12. A method, comprising:
conveying natural gas in a pipeline, the pipeline including:
a choke valve arranged in the pipeline; and
one or more adjustable restriction orifices arranged within the pipeline upstream from the choke valve and spaced from each other to thereby define at least a first pipeline section and a second pipeline section;
monitoring a first pressure within the first pipeline section with a first pressure gauge;
monitoring a second pressure within the second pipeline section with a second pressure gauge;
communicating the first and second pressures to a control system in communication with the first and second pressure gauges;
communicating a command signal from the control system to an actuation mechanism of at least one of the one or more adjustable restriction orifices when at least one of the first and second pressures exceeds a predetermined pressure threshold; and
adjusting a size of the at least one of the one or more adjustable restriction orifices based on the command signal and thereby altering the first or second pressures within the pipeline.

13. The method of claim 12, wherein the command signal comprises a first command signal, the method further comprising:
monitoring a first temperature within the first pipeline section with a first temperature gauge;
monitoring a second temperature within the second pipeline section with a second temperature gauge;
communicating the first and second temperatures to the control system in communication with the first and second temperature gauges;
communicating a second command signal from the control system to a heating element mounted to the pipeline at one or both of the first and second pipeline sections when at least one of the first or second temperatures descend below a predetermined temperature threshold; and
increasing at least one of the first and second temperatures with the heating element.

14. The method of claim 13, further comprising increasing the at least one of the first and second temperatures until exceeding the predetermined temperature threshold.

15. The method of claim 12, further comprising autonomously actuating the one or more adjustable restriction orifices when at least one of the first and second pressures exceeds the predetermined pressure threshold.
